(19) United States
(12) Patent Application Publication
(10) Pub. No.: US 2026/0317055 A1
(43) Pub. Date: Oct. 15, 2026

(54) DEBRIS BARRIER APPARATUS FOR CABINET-MOUNTED PULL-OUT WASTE RECEPTACLE SYSTEMS

(71) Applicants: Kevin James La Forest, Seattle, WA (US); Salvatore Cirillo, Seattle, WA (US)

(72) Inventors: Kevin James La Forest, Seattle, WA (US); Salvatore Cirillo, Seattle, WA (US)

(21) Appl. No.: 19/632,967

(22) Filed: Mar. 30, 2026

Related U.S. Application Data
(60) Provisional application No. 63/757,555, filed on Apr. 7, 2025.

(51) Int. Cl. B65F 1/14; B65F 1/06

(52) U.S. Cl. CPC B65F 1/14; B65F 1/06

(57) ABSTRACT

A debris barrier apparatus for cabinet-mounted pull-out waste receptacle systems. The apparatus comprises a barrier panel and a coupling assembly configured to engage the rim of a waste receptacle. The coupling assembly includes a bag accommodation channel that permits a liner bag to be installed over the receptacle rim in the conventional manner. When installed, the barrier panel extends above the receptacle rim to close the gap between the receptacle and the cabinet interior, preventing debris from escaping the receptacle and accumulating in the cabinet cavity. The apparatus attaches without tools, adhesive, or permanent modification, and may be provided in multiple sizes to accommodate variations in cabinet clearance.

### CROSS-REFERENCE TO RELATED APPLICATIONS

This application claims the benefit of U.S. Provisional Application No. 63/757,555, filed Apr. 2, 2025, which is incorporated by reference herein in its entirety.

### FIELD OF THE INVENTION

The present invention relates to accessories for cabinet-mounted pull-out waste receptacle systems. More particularly, the invention relates to a barrier apparatus configured to close the gap between a waste receptacle and an interior cabinet surface, thereby preventing debris from escaping the receptacle and accumulating within the cabinet cavity.

### BACKGROUND OF THE INVENTION

### The Cabinet Gap Problem

Pull-out waste receptacle systems have become standard features in modern residential and commercial cabinetry. These systems typically comprise a sliding drawer or rail-mounted platform that supports one or more waste receptacles within an enclosed cabinet space, commonly positioned beneath a countertop in kitchen, bathroom, or utility room applications.

A persistent and largely unaddressed deficiency exists in virtually all pull-out waste receptacle installations: a gap exists between the upper boundary of the waste receptacle and the underside of the countertop or cabinet interior. This gap, which may range from approximately one inch to six inches depending on cabinet configuration and receptacle height, creates an unobstructed pathway through which waste materials may escape the receptacle and accumulate within the cabinet cavity.

### Failure Modes

The gap produces multiple failure modes during normal use:
Trajectory Failures. When a user deposits waste into the receptacle, items that miss the receptacle opening or bounce off the receptacle rim may pass through the gap and fall into the cabinet cavity behind or beside the receptacle.
Overflow Failures. As the receptacle approaches capacity, items placed atop existing waste may slide or roll toward the receptacle perimeter and pass through the gap.
Rebound Failures. Items deposited with force may rebound from the bag interior or accumulated waste and exit through the gap.

### Consequences of the Gap

Debris that passes through the gap accumulates in a cabinet cavity that is difficult to access, visually obscured during normal use, and positioned behind the receptacle and its sliding mechanism. Consequences include:
1. Sanitation degradation. Organic waste decomposing in an enclosed, unventilated space produces odors, attracts pests, and creates unsanitary conditions.
2. Cleaning difficulty. Removal of accumulated debris requires the user to either reach into a narrow space behind the receptacle or fully remove the pull-out mechanism from the cabinet, both of which present ergonomic challenges, particularly for users with limited mobility.
3. Mechanical interference. Accumulated debris may obstruct the sliding mechanism, preventing the drawer from fully closing or operating smoothly.
4. Premature bag disposal. Users who recognize the gap problem may dispose of bags before reaching capacity to avoid overflow, resulting in inefficient bag utilization and increased waste.

### Inadequacy of Existing Solutions

Existing approaches fail to address the gap problem:
Lidded receptacles require additional user interaction to deposit waste, present operational challenges in confined cabinet spaces, and do not address debris that bypasses the receptacle entirely.
Oversized receptacles reduce but do not eliminate the gap and may not fit within standard cabinet dimensions.
DIY modifications such as foam inserts or cardboard barriers are temporary, unsanitary, and aesthetically unacceptable.
Rim-mounted bag retainers and liner retention devices are known in the waste receptacle field. These devices engage the rim of a waste receptacle to secure a liner bag in position and, in some configurations, to vent air trapped between the bag and the receptacle wall. While such devices address the problem of bag slippage during use, they are circumferential collar-type structures that do not include any vertical barrier extending above the receptacle rim. They do not address, and are not configured to address, the gap between the receptacle and the cabinet interior through which debris escapes.
Frame-integrated backsplashes, found in certain manufacturer-specific pull-out drawer systems, are structural components of the drawer frame itself. Because they are fixed elements of the drawer frame, they travel with the drawer during operation, they address debris migration at the base and rear of the frame rather than at the rim-to-countertop gap, and they are not available as aftermarket accessories for the millions of existing pull-out installations that lack such features.
Cabinet-mounted chutes and deflectors, including door-mounted ramp structures, are designed to guide refuse into a receptacle when a cabinet door is partially open. These devices mount to the cabinet structure rather than to the receptacle, do not travel with the receptacle during pull-out operation, and do not accommodate or preserve standard liner bag installation on the receptacle rim.

An effective solution to the gap problem requires three simultaneous capabilities: (1) attachment to the receptacle rim without permanent modification to the cabinet or pull-out mechanism, (2) preservation of standard liner bag installation and removal over the receptacle rim, and (3) vertical barrier coverage extending from the receptacle rim toward the cabinet interior to close the gap through which debris escapes. Existing solutions address at most two of these three requirements. No commercially available accessory addresses all three while maintaining the open-top convenience that makes pull-out systems desirable.

### SUMMARY OF THE INVENTION

The present invention provides a barrier apparatus specifically designed for cabinet-mounted pull-out waste receptacle systems. The apparatus comprises a barrier panel and a coupling assembly configured to engage the rim of a waste receptacle. The apparatus simultaneously provides three geometrically integrated functions in a single accessory: rim engagement for tool-less attachment to the receptacle, a bag accommodation channel that preserves standard liner bag installation, and a vertical barrier panel that extends upward from the receptacle rim to close the gap between the receptacle and the cabinet interior, thereby preventing debris from escaping the receptacle and accumulating within the cabinet cavity.

The apparatus attaches to the receptacle without tools, adhesive, or permanent modification to the receptacle or cabinet. The coupling assembly includes a bag accommodation channel that permits a liner bag to be installed over the receptacle rim in the conventional manner, preserving normal bag installation and removal procedures.

In preferred embodiments, the apparatus is configured as a single-sided barrier positioned along one edge of the receptacle, typically the rear edge where debris accumulation is most problematic due to the geometry of user interaction and the position of the cabinet cavity.

The apparatus may be provided in multiple sizes to accommodate variations in cabinet clearance, and the coupling assembly may be configured to accommodate variations in receptacle rim geometry.

### BRIEF DESCRIPTION OF THE DRAWINGS

FIG. 1 is a front perspective view of the debris barrier apparatus (10) showing the barrier panel (12) with decorative surface pattern (16), coupling assembly (20) at the lower edge, and S-curve rim engagement structure (22) visible at the right side.

FIG. 2 is a left side elevation view showing the barrier panel (12) in profile and the S-curve coupling assembly (20) in cross-section, illustrating the dual-channel rim engagement structure (22, 24) forming the characteristic S-curve profile.

FIG. 3 is a right side elevation view showing the mirror configuration of the S-curve coupling assembly (20), confirming the symmetrical construction of the rim engagement structure.

FIG. 4 is a top plan view showing the barrier panel (12) from above, illustrating the panel width dimension and the coupling assembly (20) extending along the lower edge, with the bag accommodation channel (26) visible as the gap between the panel body and the coupling structure.

FIG. 5 is a rear elevation view showing the cabinet-facing surface of the barrier panel (12), which is substantially planar and smooth, with the coupling assembly (20) visible at the lower edge.

FIG. 6 is a rear perspective view showing the relationship between the barrier panel (12) rear surface and the S-curve coupling assembly (20).

FIG. 7 is a bottom plan view looking upward into the coupling assembly (20), showing the interior geometry of the S-curve rim engagement structure (22, 24) and the bag accommodation channel (26).

FIG. 8 is a front elevation view showing the user-facing surface of the barrier panel (12) with decorative surface pattern (16) and the coupling assembly (20) at the lower edge.

FIG. 9 is a bottom perspective view illustrating the underside of the apparatus, showing the barrier panel (12), coupling assembly (20), and the spatial relationship between the panel and the S-curve rim engagement structure (22).

FIG. 10 is a side elevation close-up view showing the apparatus installed on a waste receptacle (40), illustrating the S-curve coupling assembly (20) engaged with the receptacle rim, with the outer rim engagement channel (22) wrapping over the top of the rim and the inner rim engagement channel (24) gripping beneath the rim.

FIG. 11 is a side elevation view showing the apparatus installed on a waste receptacle (40), illustrating the barrier panel (12) extending vertically above the receptacle rim and the S-curve coupling assembly (20) in the engaged position.

FIG. 12 is a side perspective close-up view showing the apparatus installed on a waste receptacle (40), illustrating the S-curve coupling assembly (20) engagement from an oblique angle, with the decorative surface pattern (16) visible on the barrier panel (12) and the bag accommodation channel (26) visible between the panel and the receptacle rim.

FIG. 13 is a front elevation view showing the apparatus installed on a waste receptacle (40), illustrating the barrier panel (12) spanning the width of the receptacle rear edge, with the bag accommodation channel (26) visible between the lower edge of the panel and the receptacle rim.

### DETAILED DESCRIPTION OF THE INVENTION

### Overview

The debris barrier apparatus of the present invention comprises two primary functional components: a barrier panel and a coupling assembly. The coupling assembly engages the rim of a waste receptacle, and the barrier panel extends upward from the coupling assembly to close the gap between the receptacle rim and the cabinet interior surface.

### Barrier Panel

The barrier panel is a substantially planar member configured to extend vertically or near-vertically from the receptacle rim. The panel presents a continuous surface that intercepts debris that would otherwise pass through the gap between the receptacle and the cabinet interior.

Geometry. The barrier panel has a width dimension configured to span a substantial portion of one edge of the receptacle opening. In preferred embodiments, the panel width is approximately 8 to 10 inches, suitable for standard residential pull-out receptacle systems. The panel has a height dimension configured to substantially close the gap between the receptacle rim and the cabinet interior. In preferred embodiments, the apparatus is provided in multiple height configurations, including approximately 2.5 inches, 3.5 inches, and 4.5 inches, to accommodate common cabinet clearance variations.

Form. The barrier panel may be substantially flat, or may include a curved or angled profile configured to direct debris toward the receptacle interior. In some embodiments, the panel may include a slight inward inclination, such that debris contacting the panel is directed downward into the receptacle rather than deflected outward.

Material. The barrier panel is formed from a rigid or semi-rigid material capable of maintaining its form under normal use conditions. Suitable materials include injection-molded thermoplastics such as ABS, polypropylene, or HDPE; formed metals; or composite materials. The material is preferably food-safe, cleanable, and resistant to moisture and household cleaning agents.

### Coupling Assembly

The coupling assembly is configured to engage the rim of a waste receptacle and to support the barrier panel in an operative position extending above the receptacle rim.

Rim Engagement Structure. The coupling assembly includes a rim engagement structure configured to engage the lip or rim of a standard waste receptacle. In preferred embodiments, the rim engagement structure comprises a channel or groove having an approximately inverted-U or S-shaped cross-sectional profile, configured to slide over and grip the receptacle rim from above. The channel engages both the outer surface and the inner surface of the receptacle rim, providing stable attachment through friction fit.

The rim engagement structure may include one or more of: a friction-fit channel sized to grip the receptacle rim; a clamping element adjustable to accommodate variations in rim thickness; a resilient gripping surface to enhance retention; or a sliding or telescoping mechanism to accommodate variations in rim width.

Bag Accommodation Channel. A critical feature of the coupling assembly is a bag accommodation channel positioned between the rim engagement structure and the barrier panel. This channel provides a pathway through which a liner bag may pass, permitting the bag to be installed over the receptacle rim in the conventional manner, with the bag edge draped over the rim and secured beneath the coupling assembly.

The bag accommodation channel is configured such that the liner bag passes through the channel and drapes over the outer surface of the receptacle rim, maintaining the standard bag installation configuration used with unmodified receptacles. This preserves the user's existing bag installation habits and permits the apparatus to be used with standard liner bags without modification.

Attachment Configuration. The coupling assembly attaches to the receptacle rim without tools, adhesive, fasteners, or permanent modification. Attachment is achieved through mechanical engagement of the rim engagement structure with the receptacle rim. The apparatus may be removed and reinstalled as needed, such as during deep cleaning or bag replacement.

### Assembly Integration

The barrier panel and coupling assembly may be formed as a unitary structure, or may be formed as separate components that are joined during manufacture or by the user during installation.

In preferred embodiments, the barrier panel and coupling assembly are integrally formed as a single injection-molded component, providing structural integrity and simplifying installation.

Geometric Integration of Functions. In embodiments employing the S-curve rim engagement structure, the dual-channel cross-sectional profile simultaneously performs three integrated functions: (1) the outer and inner rim engagement channels grip the receptacle rim to provide stable, tool-less attachment; (2) the spatial relationship between the rim engagement structure and the barrier panel inherently defines the bag accommodation channel as a geometric consequence of the coupling profile, rather than as a separately formed feature; and (3) the rim engagement structure provides the structural foundation from which the barrier panel extends vertically above the receptacle rim. These three functions are achieved through a single, continuous geometry rather than through independently assembled components.

### Installation and Operation

Installation. The user positions the coupling assembly over the receptacle rim at the desired location, typically the rear edge of the receptacle. The rim engagement structure is pressed downward to engage the receptacle rim, securing the apparatus in position through friction fit.

Retrofit Compatibility. Because the apparatus attaches directly to the receptacle rim rather than to the cabinet frame, drawer system, or rail mechanism, it is compatible with any standard pull-out waste receptacle system regardless of manufacturer, rail type, or cabinet configuration. The apparatus may be installed on existing pull-out systems without modification to the cabinet, countertop, pull-out mechanism, or receptacle. This retrofit capability distinguishes the apparatus from frame-integrated solutions, which are available only as components of specific manufacturer pull-out systems and cannot be added to pre-existing installations.

Bag Installation. With the apparatus installed, the user installs a liner bag by draping the bag over the receptacle rim in the conventional manner. The bag edge passes through the bag accommodation channel, between the rim engagement structure and the barrier panel, and drapes over the outer surface of the receptacle rim.

Operation. During use, waste materials are deposited into the receptacle through the open top, as with an unmodified receptacle. The barrier panel intercepts debris that would otherwise pass through the gap between the receptacle rim and the cabinet interior, containing such debris within the receptacle or deflecting it back toward the receptacle opening.

Maintenance. The apparatus may be removed for cleaning by lifting the coupling assembly from the receptacle rim. The apparatus may be cleaned with standard household cleaning agents and reinstalled.

### Sizing System

To accommodate variations in cabinet clearance, the apparatus is preferably provided in multiple height configurations, allowing users to select the appropriate configuration for their installation.

Size Designations. In preferred embodiments, three size configurations are provided: Small, approximately 2.5 inches panel height; Medium, approximately 3.5 inches panel height; and Large, approximately 4.5 inches panel height.

Additional size configurations, such as extra-small (panel height below approximately 2.5 inches) or extra-large (panel height above approximately 4.5 inches), may be provided to accommodate non-standard cabinet clearances or commercial applications. The sizing system is expandable, and additional height configurations may be added without departing from the scope of the invention.

Size Selection. The user measures the gap between the top of the receptacle rim and the underside of the countertop or cabinet interior. The user selects the apparatus size having a height dimension that substantially closes this gap without interfering with drawer operation or countertop clearance.

Sizing Guidance. When the measured gap falls between size designations, the smaller size is recommended to ensure clearance during drawer operation.

### Alternative Embodiments

Adjustable Height. In alternative embodiments, the barrier panel may be adjustable in height. Adjustment mechanisms may include telescoping panel sections, detent-based positioning, or friction-based adjustment.

Multiple Panels. In alternative embodiments, multiple apparatus units may be installed on a single receptacle, such as at the rear and one or both sides, to provide multi-sided barrier coverage.

Integrated Receptacle. In alternative embodiments, the barrier apparatus may be integrally formed with a waste receptacle as a unitary product.

Accessory Attachment Feature. In alternative embodiments, the barrier panel may include an attachment feature on the rear surface (the surface facing the cabinet interior) configured to receive an accessory device. Such accessories may include odor-control devices, air fresheners, moisture absorbers, or other functional elements. The attachment feature may comprise a clip, slot, magnetic mount, adhesive surface, or other coupling mechanism configured to retain an accessory in operative position on the barrier panel.

Color and Finish. The apparatus may be provided in multiple colors and surface finishes to coordinate with receptacle and cabinet aesthetics. Preferred colorways include black, white, and accent colors.

### REFERENCE NUMBER LEGEND

| Ref | Element | Description |
|---|---|---|
| 10 | Debris barrier apparatus | Complete assembly comprising barrier panel and |
| | | coupling assembly |
| 12 | Barrier panel | Substantially planar rigid panel extending vertically |
| | | above receptacle rim |
| 14 | Upper edge | Top edge of barrier panel, extends above receptacle rim |
| | | when installed |
| 16 | Decorative surface pattern | Hexagonal pattern on front face (aesthetic, non- |
| | | functional) |
| 18 | Lower edge | Bottom edge of barrier panel where it joins coupling |
| | | assembly |
| 20 | Coupling assembly | Attachment mechanism extending from lower edge of |
| | | barrier panel |
| 22 | Outer rim engagement channel | Outer loop of S-curve that wraps around exterior of |
| | | receptacle rim |
| 24 | Inner rim engagement channel | Inner loop of S-curve that engages interior of receptacle |
| | | rim |
| 26 | Bag accommodation channel | Gap between barrier panel and coupling assembly for bag |
| | | draping |
| 28 | S-curve profile | Characteristic double-loop cross-sectional shape of rim |
| | | engagement |
| 30 | Front surface | User-facing surface of barrier panel |
| 32 | Rear surface | Cabinet-facing surface of barrier panel |
| 40 | Waste receptacle | The bin or container to which the apparatus attaches |

### Drawing Notes

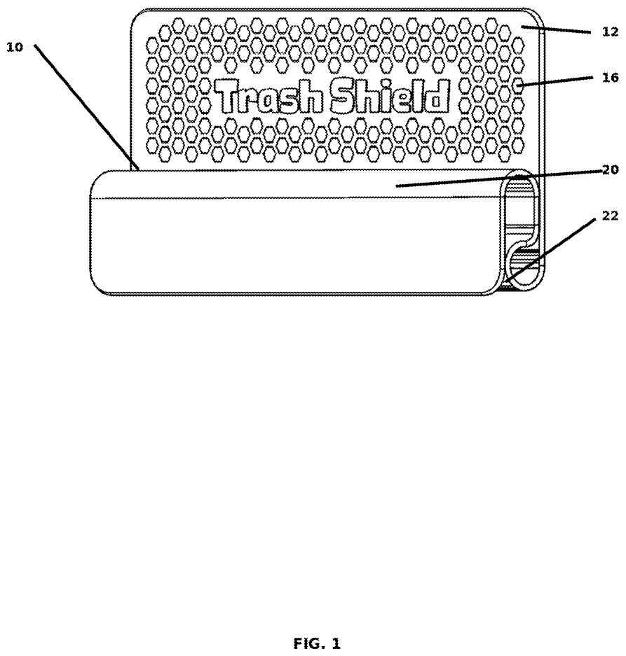

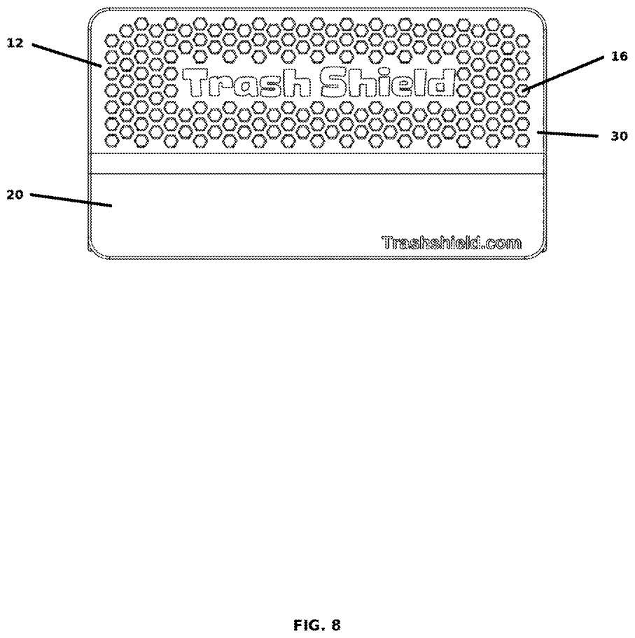

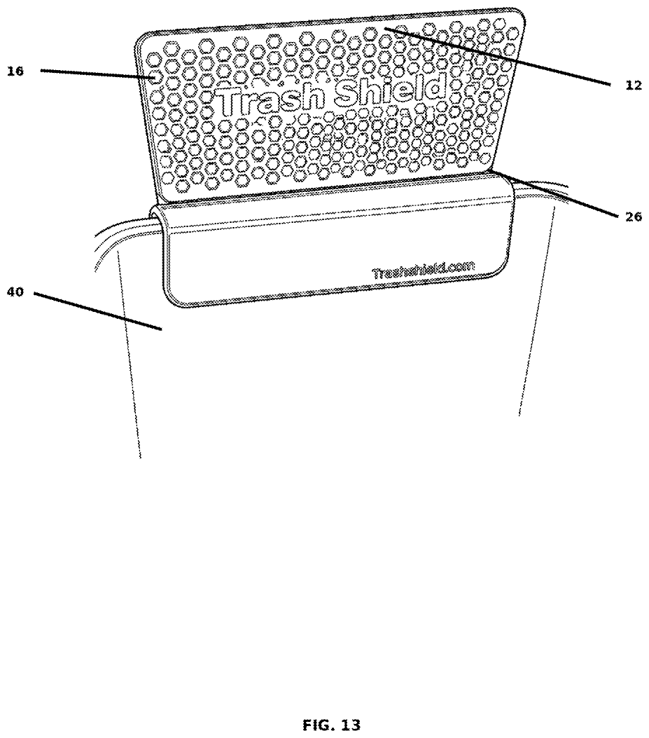

The “Trash Shield” and “Trashshield.com” text visible in FIGS. 1, 8, and 13 are shown for product identification purposes only and do not form part of the claimed invention.

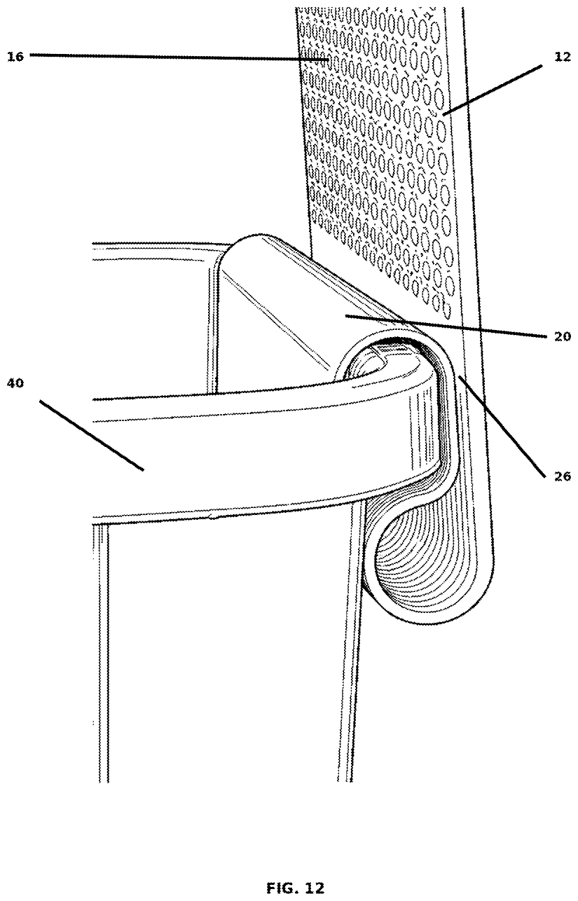

The hexagonal surface pattern (16) shown in FIGS. 1, 8, 12, and 13 is a decorative feature. The claims cover barrier panels with or without decorative surface treatments.

Drawings show the apparatus in a neutral color for clarity. The apparatus may be manufactured in multiple colors.

Drawings are not to scale. Refer to the specification for dimensional ranges.

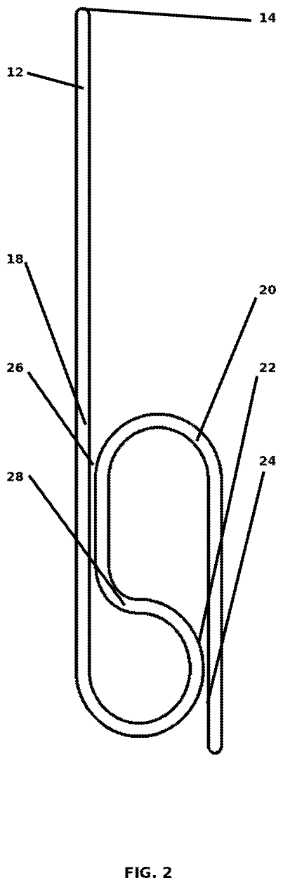

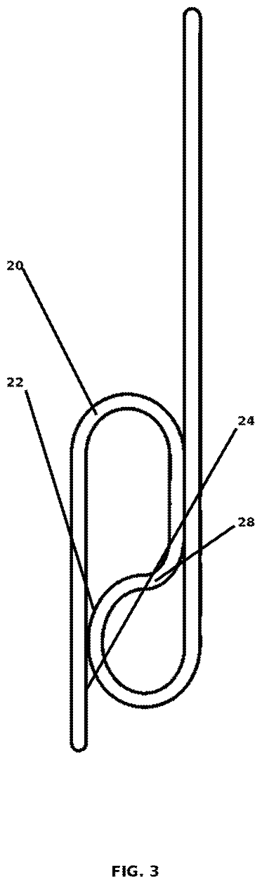

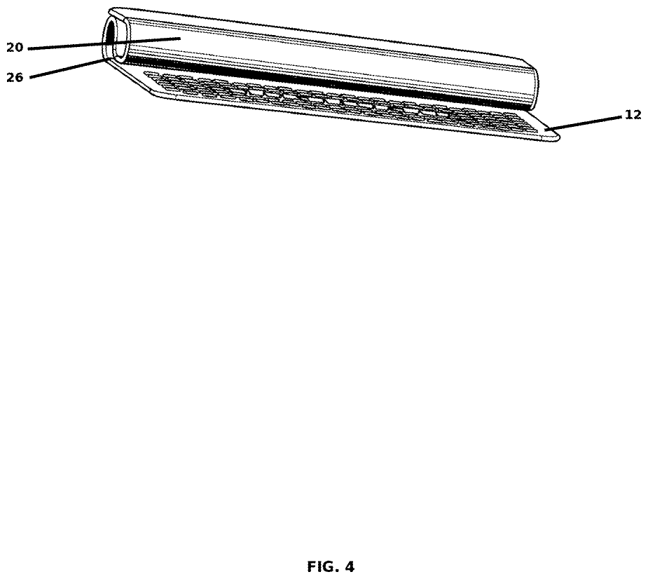

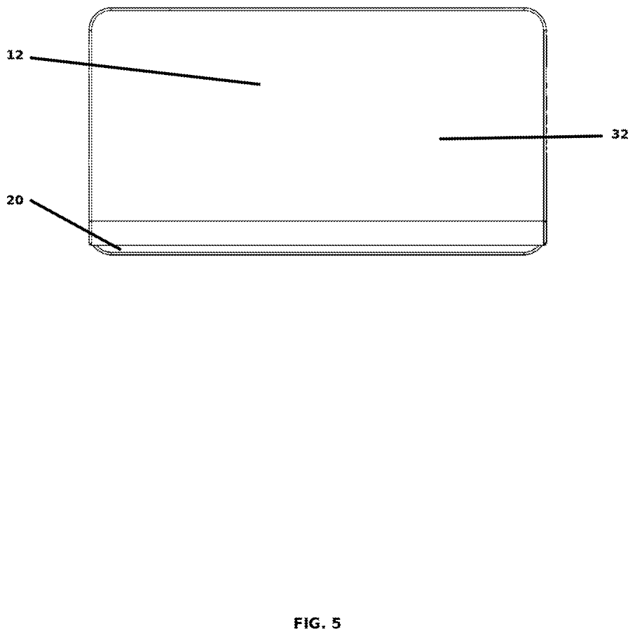

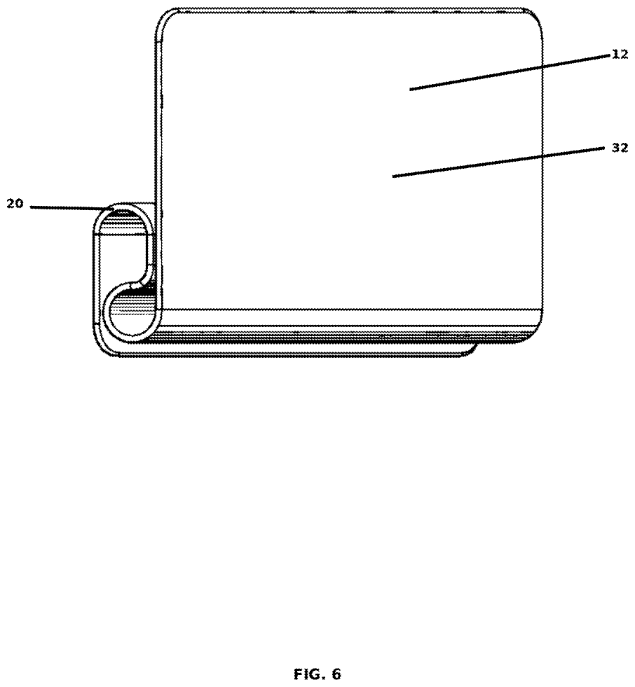

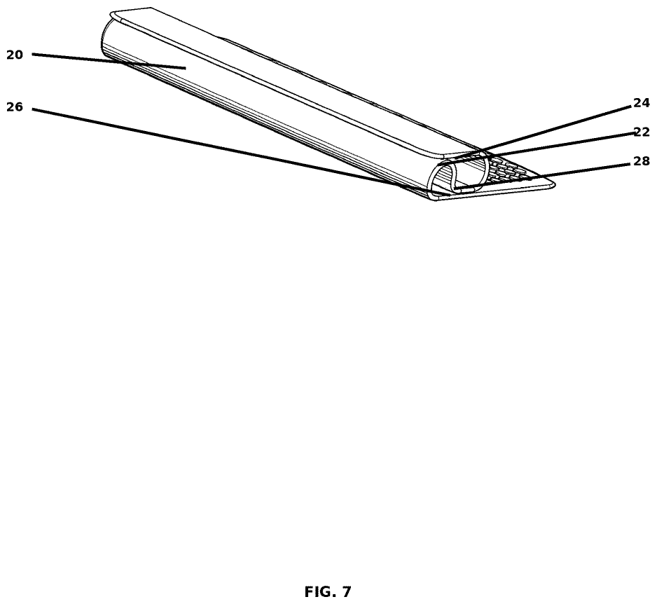

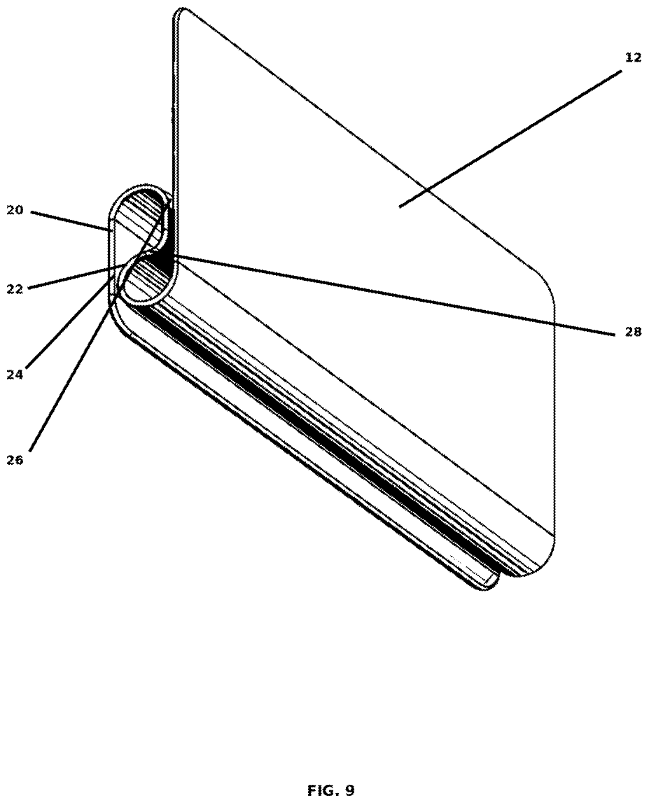

FIGS. 1-9 are computer-generated renderings from the production CAD model.

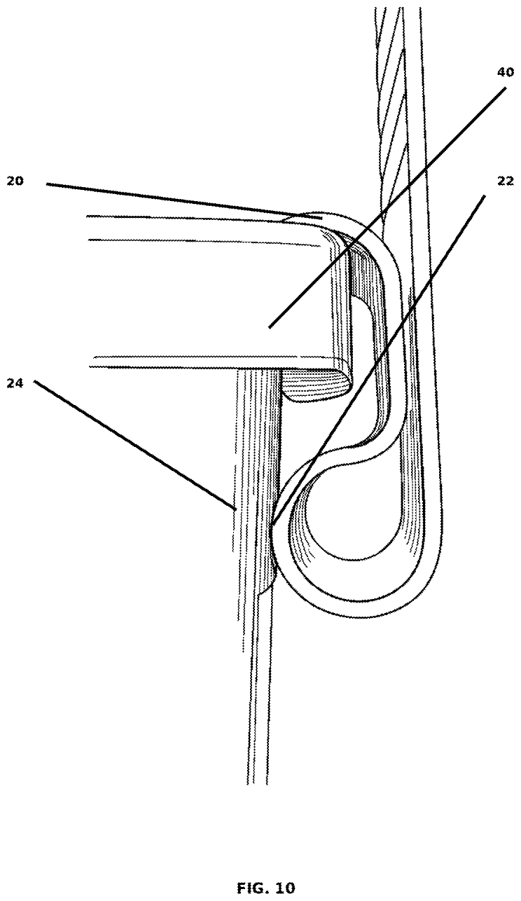

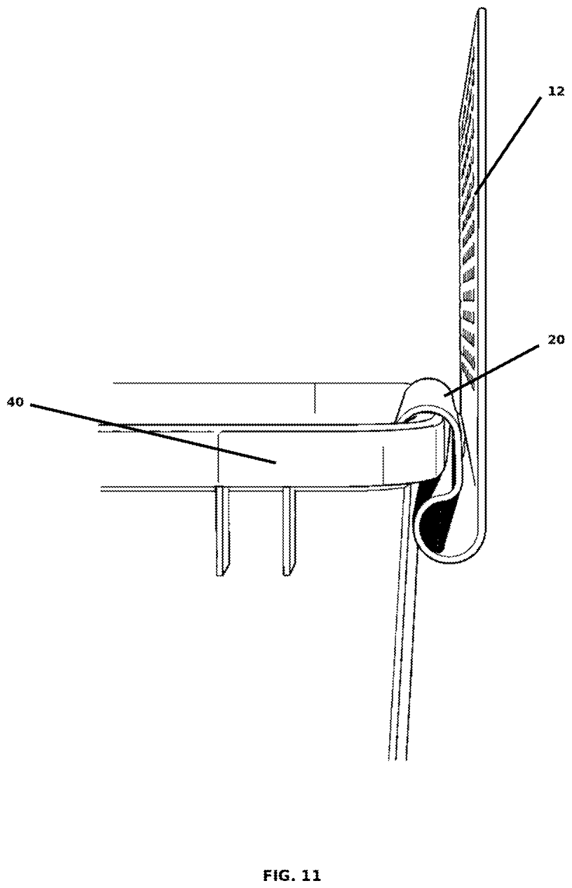

FIGS. 10-13 are photographs of the apparatus installed on a waste receptacle, illustrating the S-curve coupling assembly in the engaged position.

What is claimed is:

1. A debris barrier apparatus for use with a cabinet-mounted pull-out waste receptacle system, the apparatus comprising:
a barrier panel having a width dimension and a height dimension; and
a coupling assembly configured to engage a rim of a waste receptacle, the coupling assembly including:
a rim engagement structure configured to engage the receptacle rim, and
a bag accommodation channel positioned to permit a liner bag to pass between the rim engagement structure and the barrier panel;
wherein the barrier panel is configured to extend above the receptacle rim when the coupling assembly is engaged with the receptacle rim, the barrier panel presenting a surface configured to intercept debris that would otherwise pass through a gap between the receptacle and an interior surface of a cabinet in which the receptacle is mounted.

2. A debris barrier apparatus for use with a waste receptacle positioned within an enclosed cabinet space, the apparatus comprising:
a substantially planar barrier panel; and
a coupling assembly joined to the barrier panel, the coupling assembly configured to removably attach to a rim of the waste receptacle without tools, adhesive, or fasteners;
wherein the coupling assembly includes a channel configured to permit a liner bag to be draped over the receptacle rim while the apparatus is attached to the receptacle;
wherein the barrier panel extends above the receptacle rim when the apparatus is attached, closing a gap between the receptacle and a cabinet interior surface to prevent debris from escaping the receptacle into the cabinet space.

3. A method of preventing debris accumulation in a cabinet containing a pull-out waste receptacle, the method comprising:
attaching a barrier apparatus to a rim of the waste receptacle, the barrier apparatus including a barrier panel and a coupling assembly having a bag accommodation channel;
installing a liner bag by passing an edge of the liner bag through the bag accommodation channel and draping the liner bag over the receptacle rim; and
depositing waste into the receptacle, wherein the barrier panel intercepts debris that would otherwise pass through a gap between the receptacle rim and an interior surface of the cabinet.

4. The apparatus of claim 1, wherein the rim engagement structure comprises a channel having an inverted-U or S-shaped cross-sectional profile configured to grip the receptacle rim from above.

5. The apparatus of claim 1, wherein the coupling assembly attaches to the receptacle rim through friction fit without tools, adhesive, or fasteners.

6. The apparatus of claim 1, wherein the barrier panel and coupling assembly are integrally formed as a unitary injection-molded component.

7. The apparatus of claim 1, wherein the barrier panel has a height dimension of between approximately 2 inches and approximately 5 inches.

8. The apparatus of claim 1, wherein the barrier panel has a width dimension of between approximately 7 inches and approximately 11 inches.

9. The apparatus of claim 1, wherein the apparatus is configured for attachment to a single edge of the receptacle rim.

10. The apparatus of claim 1, wherein the barrier panel is configured to extend substantially perpendicular to a plane defined by the receptacle rim.

11. The apparatus of claim 1, wherein the barrier panel includes a surface angled toward an interior of the receptacle, the angled surface configured to direct debris toward the receptacle interior.

12. The apparatus of claim 1, wherein the coupling assembly includes an adjustable clamping element configured to accommodate variations in receptacle rim thickness.

13. The apparatus of claim 1, wherein the apparatus is formed from injection-molded thermoplastic material.

14. The apparatus of claim 1, wherein the apparatus is provided in a plurality of height configurations to accommodate variations in cabinet clearance.

15. The apparatus of claim 14, wherein the plurality of height configurations includes at least three sizes having panel heights of approximately 2.5 inches, approximately 3.5 inches, and approximately 4.5 inches.

16. The apparatus of claim 1, wherein the barrier panel includes a curved profile configured to direct debris toward the receptacle interior.

17. The apparatus of claim 2, wherein the barrier panel is substantially rigid.

18. The apparatus of claim 2, wherein the apparatus is removable from the receptacle rim for cleaning.

19. The apparatus of claim 2, wherein the channel permits the liner bag to be draped over the receptacle rim in a configuration substantially identical to a liner bag installation on an unmodified receptacle.

20. The method of claim 3, wherein attaching the barrier apparatus comprises pressing the coupling assembly onto the receptacle rim to achieve friction-fit engagement.
